(19) United States
(12) Patent Application Publication
(10) Pub. No.: US 2009/0008187 A1
(43) Pub. Date: Jan. 8, 2009

(54) Attachment and storage system for an extendible ladder

(76) Inventor: Richard J. Garelick, Minneapolis, MN (US)

Correspondence Address: Marvin Jacobson;Jacobson and Johnson, Suite 285, One West Water Street, St. Paul, MN, 55107-2080, US

(21) Appl. No.: 11/824,224

(22) Filed: Jul. 2, 2007

(51) Int. Cl. E06C 9/06

(52) U.S. Cl. 182/91; 182/97

(57) ABSTRACT

A ladder is pivotally attached to a supporting surface via a pair of arms and rests on the supporting surface when stored or not in use and is pivotally raised from the supporting surface and swung upward and outward from the supporting surface for use.

### FIELD OF THE INVENTION

This invention is directed toward a ladder which is pivotally attached to a platform or some similar support surface with mechanisms for allowing the ladder to be swung outward and downward from the platform for use to climb up and/or down the ladder and to be swung to a stowed or stored position resting against the platform or other supporting surface when not in use. As a particular feature, the ladder is releasably locked in the use position to prevent it from swaying.

### DESCRIPTION OF THE PRIOR ART

A version of a swingable storable ladder as used on a boat is shown and described in Garelick U.S. Pat. No. 5,117,940 and comprises a boat ladder which is normally stowed upright in pivotable brackets alongside the deck of a boat and which is swung outward and downward from the deck edge for use to climb into or out of the boat and when not being used can be swung back to its upright stowed position. Another prior art device is Garelick, et al. U.S. U.S. Pat. No. 6,755,146 which illustrates and describes a boat ladder which is folded into a compact form for storing or stowing in an elongated chamber parallel to or on the deck of the boat and is pulled out of the chamber, unfolded and pivotally swung downward from the open end of the chamber for use and refolded and reinserted into the chamber for stowing after use.

These and other commercially available ladders usually require a separate storage area or are inconveniently stored when not in use and also are quite cumbersome to maneuver between the stowed and the use positions.

### SUMMARY OF THE INVENTION

For convenience and ease of description, the boat ladder and its associated apparatus is described as it is used on a leisure or recreational boat or other water vehicle. When not in use or when stored or stowed, the ladder, which has conventional elongated parallel rigid side support members with at least one rung or step attached in a conventional fashion, lays flat on a platform or the deck of a boat or some such supporting surface. A pair of elongated rigid arms are pivotally attached at about one end to the supporting platform with the ladder resting between the arms and in fairly close proximity thereto. At about the other end of the arms, the ends of the ladder support members (what might be considered the upper end) are pivotally attached to the other ends of the respective arms. The supporting platform is located so that an edge is fairly close to the outer edge of the boat deck or hull. To put the ladder into use, it is pivotally raised from the rest position on the platform to an angled position with respect to the arms and then lifted to pivotally swing the arms away from the support surface or platform and to swing the ladder over the outer edge of the platform and the boat so that the ladder is extended downward into or at least toward the water so it can be used for climbing into or out of the boat. When not in use the ladder is lifted from its downward direction to swing the arms back to their rest positions on the platform and the ladder is then pivotally swung downward to rest against the platform for storage or stowing.

As a further feature, the ladder has a mechanism or apparatus for releasably locking it at its angled position with respect to the arms when it is raised from the platform so when it is swung over the side of the boat any sway when being used or caused by wavy or choppy water will be minimized even though the ladder does not rest against the boat hull. When the ladder is not being used it is brought back up from the water as described hereinabove and the locking mechanism is released so that the ladder can be pivotally swung down from the end of the arms to its stowed position on the platform.

### BRIEF DESCRIPTION OF THE DRAWINGS

FIG. 1 is an illustration of an embodiment of the invention in which the ladder is in the stowed or stored position;

FIG. 2 is an illustration of the embodiment of the invention showing the ladder raised from the stowed position to an intermediate position;

FIG. 3 is an illustration showing the ladder extended outward and downward into the use position;

FIG. 4 is a side view of FIG. 2;

FIG. 5 is a side view of FIG. 3;

FIG. 6 is an enlarged view illustrating the junction between the ladder and the arm to which it is pivotally attached; and

FIG. 7 is a breakaway or section view illustrating a releasable locking means between the ladder and its pivotal attachment to the arm.

### DESCRIPTION OF THE PREFERRED EMBODIMENTS

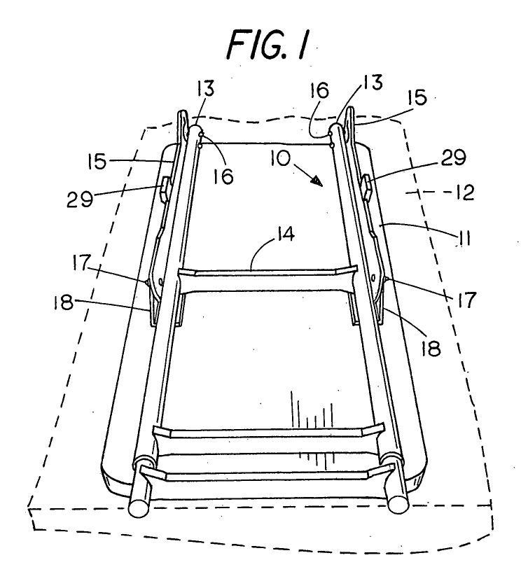

FIGS. 1-3 illustrate an embodiment of the invention in the form of a boat ladder and the apparatus for coupling the boat ladder to a recreational or leisure type boat or water vehicle for storing or stowing the ladder on the boat when not in use and for moving the boat ladder from the stored position to extend it outward and downward from an outer edge of the boat for use in climbing into or out of the boat.

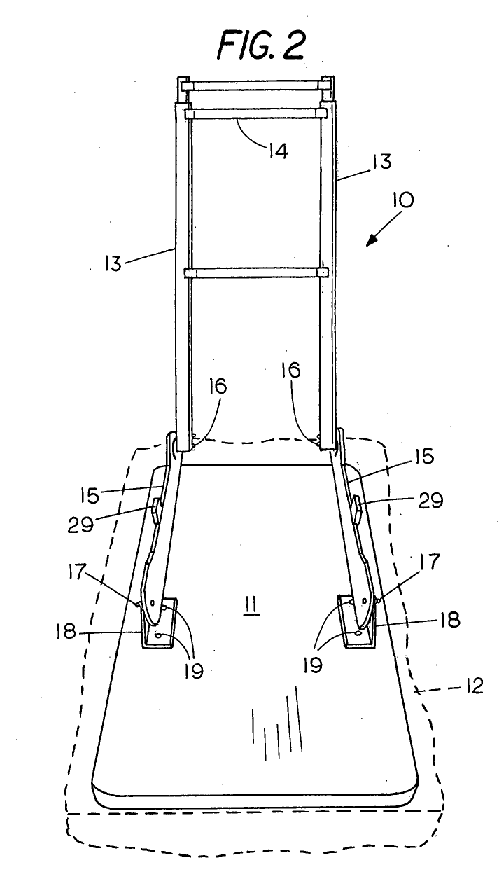

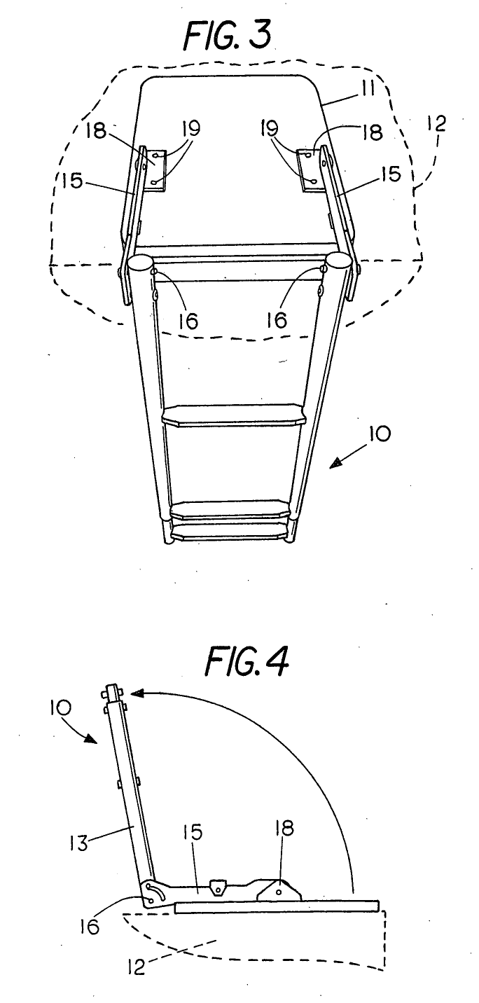

In FIG. 1 a ladder 10 rests on a platform or similar supporting surface 11 which may be the deck of a boat 12 shown in phantom line. The ladder comprises conventional outer elongated laterally spaced rigid support members 13 and at least one conventional step or rung 14 fixedly and suitably attached between the supports 13. Ladder 10 rests between a pair of arms or gudgeons 15 mounted on platform 11 with the ladder support members 13 in close proximity to respective ones of said arms 15. At about one end of the ladder support members 13 and a corresponding end of arms or gudgeons 15, a pivot pin 16 extends laterally or radially outward from each of the ladder supports 13 and is rotatably engaged with the respectively corresponding arm 15 whereby the ladder is rotatably coupled to an end of arms 15 enabling the ladder to be lifted from its stored or stowed position, as illustrated in FIG. 1, and elevated to an angled intermediate position, such as illustrated in FIG. 2, while still coupled or attached to the boat. At about their other ends arms 15 are rotatably mounted via pivot pins 17 to angle braces 18 which are fixedly mounted in some convenient and conventional fashion, such as by bolts 19, to support surface 11 whereby arms 15 can be pivotally raised off the platform and swung 180° from the positions shown in FIG. 1. This combination of elements provides means by which the ladder can be raised or lifted from the stowed position, as illustrated in FIG. 1, to an intermediate angled position, as illustrated in FIG. 2, and then swung into a use position illustrated in FIG. 3 with ladder 10 extending outside an edge of boat 12 and downward from supporting surface 11.

As stated earlier hereinabove, an added feature of the invention is that the ladder is releasably locked in the use position so that when it is extended downward it has minimum sway. When used on a boat, swaying often occurs if the water is a little choppy or if the boat sways even if anchored or docked. Conventionally boat ladders which are extended over the side edge of the boat rest against the hull of the boat to help keep the ladder from swaying when in use. This is not preferable because the side or edge of the boat may be marred or otherwise damaged and at best it may only partly keep the ladder from swaying.

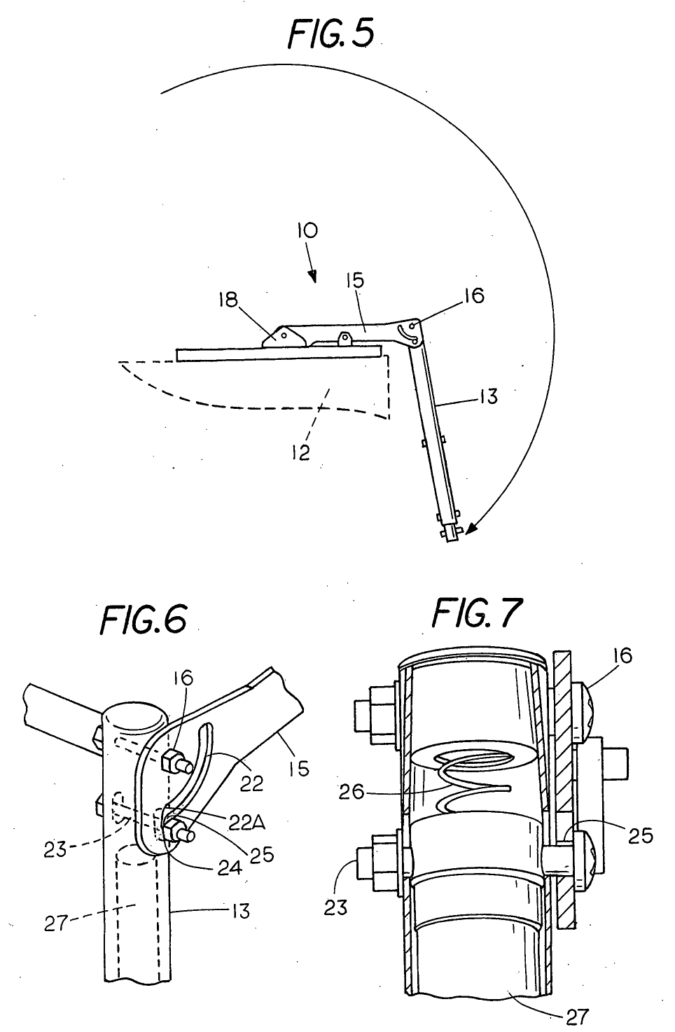

The mechanism for providing the releasable locking of the boat ladder when in the use position is most clearly shown in FIGS. 6 and 7. An arcuate or curved slot 22 is formed in each of the arms 15 at the ends thereof at which the boat ladder is pivotally attached. Extending laterally or radially outward from the ladder support members 13 are guide pins 23 which engage slots 22 so that as the ladder 10 is pivotally raised from the stowed position as explained hereinabove pins 23 follow in the track established by slot 22. At one end 22A slot 22 has a cutout 24. Pin 23 is slidably engaged in a short slot 25 in the support member 13 and is biased such as by spring 26 located within the support member 13 to engage cutout 24 when the ladder is raised and the guide pin 23 reaches the cutout end of slot 22. When that occurs the ladder is then locked onto the end of arm 15 so that when the ladder is further raised and extended over the outer edge of the boat, as shown in FIGS. 3 and 5, it is in a locked condition to help prevent it from swaying. To release the ladder from this locked condition so that it eventually can be folded back into its previously described stored position, as shown in FIG. 1, an elongated member 27 is telescopically slidably engaged within support member 13 and extends out an end of support member 13 so that it can be manually moved to move guide pin 23 against the force of spring 26 to release it from the locking notch or cutout and allow the ladder then to be pivotally swung back to its stored or stowed position.

For ease in climbing into or out of a boat the arc of curved slot 22 should range from about 70° to about 90°.

Pads 29 are fixedly attached to arms 15 in some convenient or conventional fashion to support arms 15 when the ladder is in its extended or use position as illustrated in FIG. 5.

While the invention is described as used on a boat, it may have wider application for use with any type of device or equipment which from time to time has need for an attached ladder which can be conveniently stowed or stored when not in use. Also, the length of the ladder can be expanded by additional support members telescopically engaged within one another.

I claim:

1. Attachment and storage apparatus for an extendible ladder comprising:
a) a ladder having a pair of parallel laterally spaced elongated rigid support members with a rung attached between said support members;
b) a supporting surface;
c) a pair of elongated parallel laterally spaced arms, each arm pivotally attached at about one end to said supporting surface;
d) said ladder support members pivotally attached at about one end to respective ones of said arms at about the other end of said arms;
e) said ladder resting on said supporting surface for storage and pivotally raised to an angled position from said supporting surface for use; and
f) said arms pivotally raised from said supporting surface to swing said ladder outward from said supporting surface when said ladder is raised.

2. The invention as described in claim 1 further including:
a) an arcuate slot in each of said arms at about said other end of said arms, said arcuate slot having a cutout at one end of the arcuate slot;
b) a guide pin extending radially outward from each of said ladder support members slidably engaging a respective one of said arcuate slots, said guide pins biased to engage said arcuate slot cutout to releasably lock said ladder to said arms when said ladder is raised to said angled position; and
c) a member slidably telescoped within each of said ladder support members manually operable to apply a force in opposition to the bias on said pins to release said pins from engagement with said arcuate slot cutouts to unlock said ladder.

3. Apparatus for stowing and extending a ladder, comprising:
a) a ladder having a pair of laterally spaced elongated rigid support members with a rung attached between said support members;
b) a supporting surface;
c) a pair of laterally spaced elongated rigid arms pivotally attached at about one end to said supporting surface, said ladder resting on said supporting surface when stowed with said ladder support members in part located adjacent to respective ones of said arms and pivotally attached thereto at about the other end of said arms;
d) a guide pin extending radially outward from each of said ladder support members toward a respective adjacent arm, said guide pins releasably locking the ladder to said arms at an angle when the ladder is swung from a stowed position resting on said supporting surface to a raised position for use; and
e) a manually operable member coupled to each of said ladder support members for applying a force on said guide pins to release the locking engagement.

4. Apparatus for mounting an attached extendible boat ladder, comprising:
a) a supporting surface on a boat, said supporting surface having an outer edge at about the outer edge of the boat hull;
b) a ladder having a pair of parallel laterally spaced elongated rigid support members and a rung attached between said support members, said ladder resting on said supporting surface when stowed;
c) a pair of laterally spaced elongated parallel rigid arms pivotally attached at about one end to said supporting surface;
d) said ladder support members each pivotally attached at about one end to a respective one of said arms at about the other end of said arms;
e) said arms pivotally raised from said supporting surface to swing the ladder over the outer edge of the boat hull for use; and
f) means for releasably locking said ladder to said arms at a prescribed angle when the ladder is raised from its stowed position.

5. Apparatus for mounting an attached extendible boat ladder as described in claim 4 wherein said means for releasably locking said ladder to said arms comprises:
a) a curved slot in each of said arm with a cutout at the end of each slot;
b) a guide pin extending radially outward from each ladder support member engaged with a respective one of said slots, said guide pins biased to engage said cutouts to lock the ladder at an angle to said arms; and
c) a member slidably telescoped within each ladder support members manually operable to apply a force to overcome the bias on said pins to release said pins from engagement with said cutouts to unlock said ladder from its locked angle.
